(19) United States
(12) Patent Application Publication
(10) Pub. No.: US 2026/0310403 A1
(43) Pub. Date: Oct. 8, 2026

(54) Adaptive User Interfaces

(71) Applicant: Google LLC, Mountain View, CA (US)

(72) Inventors: Gaetano Ling, Palo Alto, CA (US); Amelia Schladow, San Francisco, CA (US); Matthew Sibigtroth, Urbana, IL (US); Benjamin Guy Alexander Pawle, London (GB); George Joseph Rickerby, London (GB); Michael Colville, London (GB)

(73) Assignee: Google LLC, Mountain View, CA (US)

(21) Appl. No.: 19/481,239

(22) PCT Filed: May 31, 2023
(86) PCT No.: PCT/US2023/067689

§ 371 Date: Nov. 4, 2025

(51) Int. Cl. G06F 3/16; G06F 3/04842; G06F 3/0488

(52) U.S. Cl. CPC G06F 3/167; G06F 3/04842; G06F 3/0488

(57) ABSTRACT

This document describes systems and techniques directed at adaptive user interfaces (UIs). In aspects, a computing device having a display, a speaker, and a UI manager is configured to output a graphical user interface (GUI) including a plurality of GUI elements. The UI manager receives a first user selection (e.g., touch input) of a GUI element and determines one or more actions that are associated with the selected GUI element. The UI manager outputs the one or more actions for display, receives a second user selection (e.g., voice input) of an action, and performs, responsive to the second user selection, the action. By so doing, the UI manager enables a user to interact seamlessly with the computing device via touch and voice inputs. This flexibility improves user experience and increases an efficiency at which the user can interact with the computing device.

### BACKGROUND

Computing devices (e.g., smartphones, smartwatches, tablets, computers) utilize a user interface (UI) to facilitate user-device interactions. Many computing devices utilize more than one type of UI to provide options and flexibility to users. Two commonly utilized UIs include touch-based interactions and audio-based interactions (e.g., voice input). The touch-based interactions can be paired with a graphical UI (GUI) so that users can see various touch targets on a display. The audio-based interactions can include audio hints, visually (e.g., by the display) or audibly (e.g., by a speaker), provided by the computing device.

However, touch-based and audio-based interactions may not be optimal for some users. Touch-based interactions can demand full attention from, require fine motor skills of, and assume literacy of users. Audio-based interactions utilize potentially awkward hot words, occur in a turn-based fashion (e.g., inefficient), lack focus (e.g., digital assistants can answer basic questions but may fail to do more complicated things reliably), and have low discoverability (e.g., the UI may not provide hot words and/or phrases to the user).

### SUMMARY

This document describes systems and techniques directed at adaptive user interfaces (UIs). In aspects, a computing device having a display, a speaker (e.g., built-in speakers, wireless headphones), and a UI manager is configured to output a UI including a plurality of UI elements. The UI can be a graphical UI (GUI) or an audio UI (AUI) where the UI elements are GUI elements (e.g., shown on the display) or AUI elements (e.g., emitted by the speaker), respectively. The UI manager receives a first user selection (e.g., touch input) of a UI element and determines one or more actions (e.g., tasks, functions) that are associated with the selected UI element. The UI manager outputs (e.g., for display, for listening) additional UI elements that are associated with the one or more actions, receives a second user selection (e.g., voice input) of an action, and performs, responsive to the second user selection, the selected action. By so doing, the UI manager enables a user to interact seamlessly with the computing device via touch and voice inputs interchangeably. This flexibility improves user experience and increases an efficiency at which the user can interact with the computing device.

The details of one or more implementations of UI managers are set forth in the accompanying Drawings and the following Detailed Description. Other features and advantages will be apparent from the Detailed Description, the Drawings, and the Claims. This Summary is provided to introduce subject matter that is further described in the Detailed Description.

### BRIEF DESCRIPTION OF THE DRAWINGS

The details of one or more aspects of UI managers are described in this document with reference to the following Drawings, in which the use of same numbers in different instances may indicate similar features or components:

FIG. 1 illustrates an example environment of a computing device having a display and a UI manager;

FIG. 2 illustrates an example implementation of the computing device from FIG. 1, which is configured to provide the UI manager;

FIG. 3 illustrates an example method for implementing a UI manager for managing a GUI;

FIG. 4 illustrates an example method for implementing a UI manager for managing an AUI;

FIG. 5 illustrates example implementations of UI managers determining actions associated with a GUI element;

FIG. 6 illustrates an example implementation of utilizing a UI manager to interact with a notetaking application;

FIG. 7 illustrates an example implementation of utilizing a UI manager to interact with a notification;

FIG. 8 illustrates an example implementation of utilizing a UI manager to edit text; and

FIG. 9 illustrates an example implementation of utilizing a UI manager to interact with a mapping application.

### DETAILED DESCRIPTION

### Overview

Computing devices (e.g., smartphones, smartwatches, tablets, computers) utilize a user interface (UI) to facilitate user-device interactions. A computing device often includes one or more input devices (e.g., a mouse, a keyboard, a microphone, a touchscreen) configured to receive inputs from a user and a graphical user interface (GUI), a touchscreen, and a microphone. The GUI presents (e.g., via a display) various GUI elements, or visual representations of actions, to the user. The touchscreen can receive touch inputs from the user, while the microphone can receive audio inputs (e.g., voice) from the user. The touch and/or audio inputs from the user can indicate a selection of one or more of the GUI elements on the display, and, responsive to the inputs, the computing device can perform the actions represented by the selected GUI elements.

Touch-based and audio-based interactions offer choice and convenience to the user. For example, touch-based interactions are intuitive and direct. Audio-based interactions, on the other hand, are less direct but enable the user to interact hands-free with the computing device. However, touch-based and audio-based interactions may include certain shortcomings, making either choice less optimal for the user.

Touch-based interactions can demand full attention from, require fine motor skills of, and assume literacy of the user. Audio-based interactions can utilize potentially awkward hot words, occur in an inefficient turn-based fashion, and have low discoverability (e.g., the UI may not provide hot words and/or phrases to the user). Further, the user typically must choose between touch-based interactions and audio-based interactions to complete a task, even if one or more portions of the task are better completed through touch-based interactions over audio-based interactions and vice versa.

This document describes systems and techniques directed at adaptive user interfaces (UIs) configured to enable the user to utilize touch-based and/or audio-based interactions optimally. The disclosed systems and techniques may address the shortcomings of touch-based and audio-based interactions by enabling the user to interact with the computing device using either manner of interaction interchangeably and/or contemporaneously. The conflict between these shortcomings may be addressed by the disclosed systems and techniques, which may provide an optimal user interaction experience.

The following discussion describes operating environments, techniques that may be employed in the operating environments, example devices, and example methods. Although systems and techniques for UI managers are described, it is to be understood that the subject of the appended claims is not necessarily limited to the specific features or methods described. Rather, the specific features and methods are disclosed as example implementations, reference to which is made by way of example only.

### Example Operating Environment

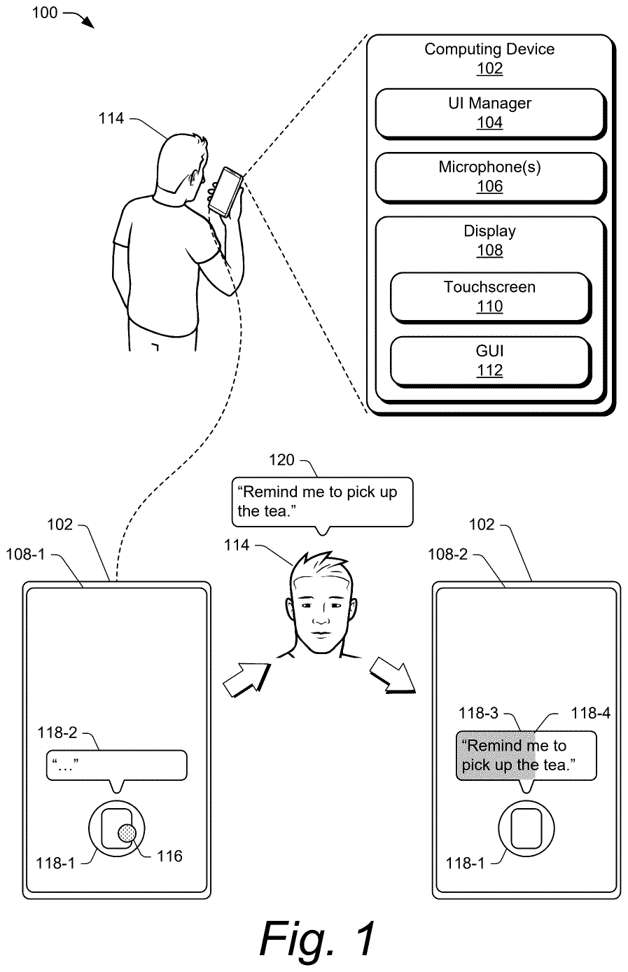

FIG. 1 illustrates an example environment 100 of a computing device 102 having a display 108 and a user interface (UI) manager 104. The computing device 102 also includes one or more microphones, which can be realized as dynamic microphones, condenser microphones, ribbon microphones, and so forth. The microphones 106 can include just one microphone for saving space within or reducing complexity of the computing device 102. Alternatively, the microphones 106 can include more than one microphone for active noise-cancelling purposes. For example, the computing device 102 can include at least one microphone on a front face of the computing device for receiving intentional audio inputs and at least one microphone on a back face of the computing device for receiving and reducing ambient audio inputs.

The display 108 can be realized as any appropriate display, including an organic light-emitting diode (OLED) display, an active-matrix OLED display, a liquid crystal display, a light-emitting diode display, and so forth. The display 108 can further include a touchscreen 110 and can provide a GUI 112 to a user 114. The GUI 112 can include one or more various GUI elements, including application icons, widgets, text fields, images, notifications, background images, and so forth. The user 114 may interact with a GUI element by providing a touch input to the touchscreen 110.

In this example environment, the user 114 wishes to interact with a notetaking application of the computing device 102. To do so, the user 114 provides a touch input 116 to the touchscreen 110 by placing a finger on the display 108-1. The touch input 116 may be any appropriate touch input, including a press-and-hold touch input, a long-press touch input, a gesture touch input, a double tap touch input, a single tap touch input, and so forth. In this example, the touch input 116 is a press-and-hold touch input where the user 114 presses the finger on the display 108-1 and holds the finger on the display 108-1. As illustrated, the touch input 116 corresponds to a first GUI element 118-1 of the GUI 112, which is an application icon for the notetaking application. The UI manager 104 receives the touch input 116 and, responsive to receiving the touch input 116, directs the display 108-1 to output a second GUI element 118-2 to the user 114. The second GUI element 118-2 is a voice cursor, which indicates to the user 114 that the UI manager 104 is waiting to receive audio input (e.g., voice input) and a location where spoken text corresponding to the audio input will be inserted for display.

The user 114 then provides a voice input 120 to the UI manager 104 via the one or more microphones 106 of the computing device 102. In this example, the user 114 provides the voice input 120 by saying, “Remind me to pick up the tea.” Responsive to receiving the voice input 120, the UI manager 104 directs the display 108-2 to output a third GUI element 118-3, which is an update to the second GUI element 118-2. As illustrated by the display 108-2, the UI manager 104 inserts text corresponding to the voice input 120 in the location indicated previously by the second GUI element 118-2. Although not shown, the user 114 may terminate the touch input 116 and the UI manager 104, responsive to the termination of the touch input 116, may direct the display 108-2 to output a fourth GUI element 118-4. The fourth GUI element 118-4 is a countdown, at the end of which the UI manager 104 may perform the action associated with the voice input 120. The countdown delays, prior to the performing of the action associated with the voice input 120, performing the action. By so doing, the UI manager 104 provides a time in which the user 114 may interrupt the performing of the action if an intent indicated by the third GUI element 118-3 is incorrect. For example, the user 114 may not have enunciated the voice input 120 clearly enough for the UI manager 104 to understand.

In this way, the UI manager 104 of the computing device 102 enables the user 114 to interact seamlessly with the computing device 102 via touch and voice inputs interchangeably. This flexibility improves user experience and increases an efficiency at which the user 114 can interact with the computing device 102. The UI manager 104 enables the user 114 to interact with the computing device 102 via the touch input 116 and the voice input 120 in an intuitive and seamless way. By so doing, the UI manager 104 provides flexibility to the user 114, which improves a user experience through an increased efficiency at which the user 114 can interact with the computing device 102.

### Example Devices

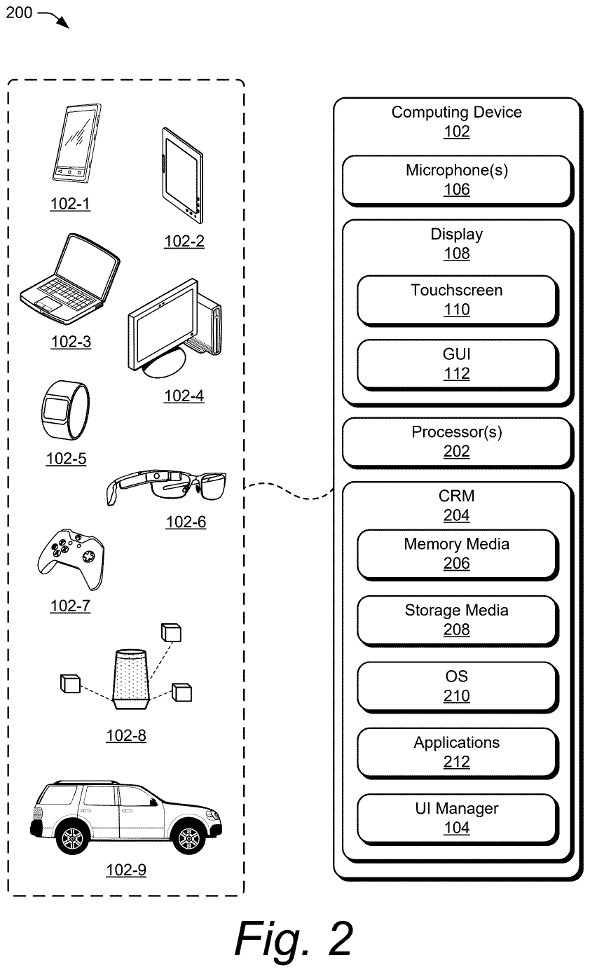

In more detail, FIG. 2 illustrates an example implementation 200 of the computing device 102 from FIG. 1, which is configured to provide the UI manager. The computing device 102 is illustrated as various example devices. As non-limiting examples, the computing device 102 can be a smartphone 102-1, a tablet 102-2, a laptop 102-3, a desktop 102-4, a smartwatch 102-5, a pair of smart glasses 102-6, a game controller 102-7, a smart home speaker 102-8, or a vehicle 102-9. Although not illustrated, the computing device 102 may also be implemented as a health monitoring device, a personal media device, a drone, a home appliance, a security system or device thereof, a digital photo frame, and so forth. The computing device 102 can be wearable, non-wearable but mobile, or relatively immobile. Further, the computing device 102 can be used with or embedded within many computing devices or peripherals, such as vehicles or personal computers. The computing device 102 may also include additional interfaces or components omitted from FIG. 2.

FIG. 2 illustrates that the computing device 102 includes various components described with reference to FIG. 1, including the one or more microphones 106, the display 108, the touchscreen 110, and the GUI 112. FIG. 2 further illustrates that the computing device 102 may include one or more processors 202 and computer-readable media 204 (CRM 204). The processors 202 may include one or more of any appropriate processor (e.g., a central processing unit, a graphics processing unit). The CRM 204 may include memory media 206 and/or storage media 208. The memory media 206 may include one or more non-transitory storage devices, such as random-access memory. The storage media 208 may include one or more transitory storage devices, such as a solid-state drive or a magnetic spinning disk drive. The computing device 102 may further include an operating system 210 (OS 210), applications 212, and a UI manager 104 stored as computer-readable instructions on the CRM 204. The one or more processors 202 can execute the computer-readable instructions on the CRM 204 to provide some or all of the functionalities described herein.

In implementations, the UI manager 104 can include one or more integrated circuits, a system on a chip, a secure key store, hardware embedded with firmware, a printed circuit board with various hardware components, or any combination thereof. As described herein, the UI manager 104 may include one or more components of the computing device 102, as illustrated in FIG. 2. In other implementations, the UI manager 104 may be the computing device 102.

Although not shown, the computing device 102 can also include additional sensors, input/output (I/O) ports, a system bus, an interconnect, or another data transfer system that couples with various components of or within the computing device 102. As examples, the additional sensors can be disposed anywhere on or in the computing device 102, or anywhere on or in a peripheral device that is connected to the computing device 102. The sensors can include an image sensor (e.g., a camera), an ambient light sensor (e.g., a photodetector), an acceleration sensor (e.g., an accelerometer), and so forth. The I/O ports can enable the computing device 102 to interact with other devices or users through peripheral devices, transmitting any combination of digital signals and/or analog signals via wired manners (e.g., ethernet) or wireless manners (e.g., radio). The I/O ports may include any combination of internal or external ports, such as universal serial bus ports, audio ports, video ports, and so forth. Various peripheral devices may be coupled with the I/O ports, such as human input devices, external CRM, speakers, and displays.

### Example Methods

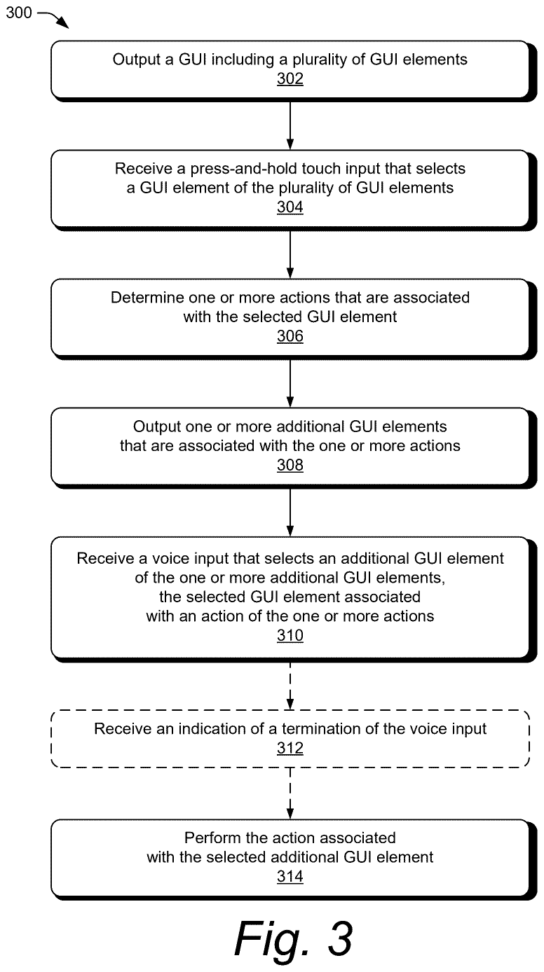

FIG. 3 illustrates an example method 300 for implementing a computing device, such as a UI manager (e.g., UI manager 104 of FIG. 1 or 2) for managing a GUI. For clarity, the UI described with reference to FIG. 3 is a GUI, but the UI can be any appropriate UI, including a GUI or an AUI. In aspects, a computing device (e.g., computing device 102) includes a processor (e.g., processors 202) and CRM (e.g., CRM 204) that includes instructions that, when executed by the processor, cause the computing device to implement a UI manager. Further, the computing device may include a display (e.g., display 108), a touchscreen (e.g., touchscreen 110), a microphone (e.g., microphones 106), and a speaker.

At 302, the UI manager outputs a GUI including a plurality of GUI elements. The GUI and GUI elements may be outputted on the display. For clarity, the UI described with reference to FIG. 3 is a GUI, but the UI can be any appropriate UI, including a GUI, an AUI, and so forth. The UI manager may output the GUI by directing the display, via a display driver integrated circuit (DDIC), for example, to output the GUI. The plurality of GUI elements can include at least one of application icons, notifications, widgets, toggles, images, videos, wallpapers, backgrounds, and so forth. Herein, the term UI element and GUI element can be used interchangeably.

At 304, the UI manager receives a user input, for example a press-and-hold touch input, that selects a GUI element of the plurality of GUI elements. The press-and-hold touch input may include touching, by a user, the GUI element of the plurality of GUI elements and maintaining contact with the GUI element for a duration of time (e.g., one second(s), 1.5 s, 3 s). The duration of time may be long enough so that the press-and-hold touch input is maintained throughout a majority of the example method 300. The selected GUI element may be an application icon, a notification, a widget, a button, and so forth.

At 306, the UI manager determines, responsive to the selection of the GUI element, one or more actions that are associated with the selected GUI element. Assuming that the selected GUI element is an application icon, for example, then the one or more actions may be actions applicable to an application, including pausing the application, clearing a cache memory associated with the application, sharing the application, moving the application on a home screen, and so forth. As another example, assuming the selected GUI element is an application icon for a notetaking application (e.g., as described with reference to FIG. 1), then the one or more actions may be actions applicable to the notetaking application, such as setting a reminder, taking a text note, taking a voice note, taking a photo note, making a list, creating a checklist, and so forth. As yet another example, assuming the selected GUI element is a notification, then the one or more actions may be actions applicable to notifications, including dismissing the notification, engaging with an application associated with the notification, snoozing the notification, deleting the notification, and the like.

At 308, the UI manager outputs one or more additional GUI elements that are associated with the one or more actions. The additional GUI elements may be outputted on the display. The additional GUI elements may be different elements not previously output with the plurality of GUI elements. Similar to outputting the GUI elements, the UI manager may direct the display, via a DDIC, to output the additional GUI elements. As an example, the UI manager may output the additional GUI elements within an intent bubble, a voice cursor (e.g., second GUI element 118-2), a list associated with the selected GUI element, and so forth. If the one or more actions include many actions (e.g., five or more), then the UI manager may output them in a rotating fashion, wherein an action of the one or more actions is highlighted (e.g., within an intent bubble, by bold text) for a duration of time (e.g., 1 s, 2.3 s) before a next action is highlighted and so forth. As another example, the UI manager may output the additional GUI elements as a grid associated with (e.g., indicated by an arrow) the selected GUI element.

At 310, the UI manager receives a voice input that selects an additional GUI element of the one or more additional GUI elements, the selected additional GUI element associated with an action of the one or more actions. The UI manager may receive the voice input via the microphone of the computing device from a user while the user is maintaining the press-and-hold touch input. The voice input may include key words or phrases that are associated with the selected GUI element that is associated with the action of the one or more actions. For example, if the selected GUI element is an application and the user wishes to share the application with a friend, the user may speak a phrase starting with “share.” As another example, if the selected GUI element is a notification associated with a messaging application, the user may speak a phrase starting with “reply” or “forward.” Additionally or alternatively, one of the one or more actions associated with the selected GUI element may be a default action for the selected GUI element. Given that replying to a message is a common interaction a user may have, then in the present example, the “reply” action of the one or more actions may be the default action. Accordingly, the user may speak a phrase that does not start with “reply,” but rather contains a message the user wants to send, and the UI manager may select the “reply” action automatically. As yet another example, if the selected GUI element is a location within a mapping application, the user may speak a phrase starting with “directions to” or “add to favorites.” At 312, the UI manager optionally receives an indication of a termination of the voice input. For example, the indication of the termination of the voice input may include a termination of the press-and-hold input (e.g., a user lifts a finger). The indication of the termination (e.g., the termination of the press-and-hold input) may indicate to the UI manager that the user has completed providing the voice input. At 314, the UI manager performs the action associated with the selected additional GUI element. The UI manager may direct the computing device, the processor, or other components not mentioned thereof to perform the action. The UI manager may perform the action responsive to the termination of the press-and-hold touch input. In more detail, the user may provide a press-and-hold touch input that selects a GUI element, speak a phrase including key words associated with an action of one or more actions associated with the GUI element, and then release the press-and-hold touch input. Responsive to the release of the press-and-hold touch input, the UI manager may perform the action.

Although not shown in FIG. 3, rather than a press-and-hold touch input, a user may provide an alternative touch input, such as a long-press touch input (e.g., a user touches a GUI element for one second), a double tap touch input, a gesture touch input, and so forth. The user may terminate the alternative touch input prior to providing the voice input. For example, the user may provide a long-press touch input, terminate the long-press touch input, and then provide a subsequent voice input. The UI manager may perform the action associated with the selected additional GUI element responsive to a termination, which may include a delay, of the subsequent voice input. In more detail, the user may provide a long-press touch input that selects a GUI element, terminate the long-press touch input, speak a phrase including key words associated with an action of at least one action associated with the GUI element, and then remain silent for a duration of time (e.g., 0.5 seconds, 1 second). The UI manager may perform the action responsive to expiration of the duration of time, which, in this example, is considered the termination of the voice input.

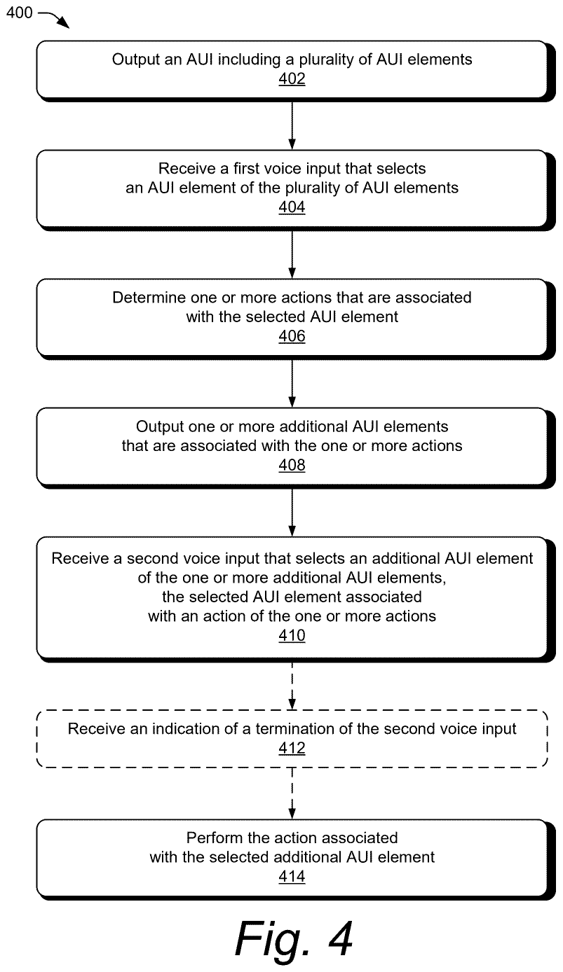

FIG. 4 illustrates an example method 400 for implementing a UI manager (e.g., UI manager 104 of FIGS. 1 or 2) for managing an AUI. For clarity, the UI described with reference to FIG. 4 is an AUI, but the UI can be any appropriate UI, including an AUI, a GUI, and so forth. In aspects, a computing device includes a processor, CRM, a display, a microphone, and a speaker. The CRM may include instructions that the processor may execute to cause the computing device to implement a UI manager. The example method 400 is similar to the example method 300 illustrated in FIG. 3 and described above, except as detailed below.

In some situations, the computing device may be too far for a user to touch, or the display may be off so that the user cannot see a plurality of GUI elements. For example, if the computing device is too far for the user to touch, the user may prompt the UI manager with a phrase such as “what can I say?” Responsive to receiving the phrase, the UI manager may output for display additional GUI elements that represent voice hints (e.g., phrases, keywords) that the user may speak to select a GUI element from the plurality of GUI elements. For example, the phrase “notes” may be output for display next to a notetaking application icon. As another example, if the display of the computing device is off, the user may provide a voice input, such as a same phrase “what can I say?” Responsive to receiving the phrase, the UI manager may perform the example method 400 detailed below.

At 402, the UI manager outputs an audio user interface (AUI) including a plurality of AUI elements. The UI manager may output the AUI by directing the speaker of the computing device, or an audio peripheral (e.g., earbuds, headphones) connected (e.g., by wire, wirelessly) with the computing device, to output in a rotating fashion (e.g., a first AUI element followed by a second AUI element, a third AUI element following the second AUI element) every AUI element of the plurality of AUI elements. The plurality of AUI elements can include at least one of application names, notification contents, widget names or contents, and so forth.

At 404, the UI manager receives a first voice input that selects an AUI element of the plurality of AUI elements. For example, the AUI element may be a phone application, which the user may select by speaking a phrase including “open phone” or “hey, phone.” As another example, the AUI element may be a stock trading widget, which the user may select by speaking a phrase including “open stocks” or “hey, stocks.”

At 406, the UI manager determines one or more actions associated with the selected AUI element. Continuing with the example of the phone application, the one or more actions may be phone-related actions, including checking voicemail, placing a call, redialing a most recent phone number, checking most recent calls, and so forth. Continuing with the example of the stock trading widget, the one or more actions may be stock-related actions, including checking a daily change in a stock, completing a stock trade (e.g., buying shares, selling shares), checking an account balance, and so forth.

At 408, the UI manager outputs one or more additional AUI elements associated with the one or more actions. Similar to outputting the AUI elements at 402, the UI manager may direct the speaker or a connected audio accessory (e.g., external speakers) to output the additional AUI elements. The UI manager may output the additional AUI elements in a listed, or rotating, fashion where a first additional AUI element is output for the user to hear, then a second additional AUI element is output, then a third additional AUI element, and so forth. The UI manager may further repeat outputting the additional AUI elements so that the user is afforded an appropriate amount of time an understanding to make a selection.

At 410, the UI manager receives a second voice input that selects an additional AUI element of the one or more additional AUI elements, the selected AUI element associated with an action of the one or more actions. The second voice input may include key words or phrases that are associated with the action of the one or more actions. For example, if the selected AUI element is an application and the user wishes to share the application with a friend, the user may speak a phrase starting with “share.” As another example, if the selected AUI element is a notification associated with a messaging application, the user may speak a phrase starting with “reply” or “forward.”

At 412, the UI manager optionally receives an indication of a termination of the second voice input. For example, the indication of the termination of the second voice input may include a termination of the second voice input (e.g., silence from a user), which may further include a delay (e.g., 0.5 s, 1 s) and indicate to the UI manager that the user has completed providing the second voice input. The UI manager, at 414, performs the action associated with the selected additional AUI element. The UI manager may direct the computing device, processor, or other components thereof to perform the action.

### General Examples

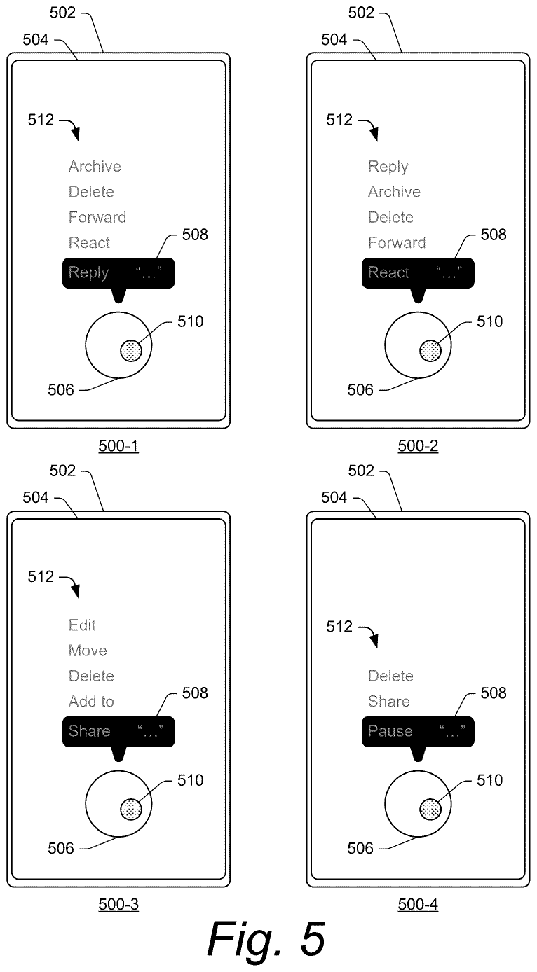

FIG. 5 illustrates example implementations 500-1 through 500-4 of a UI manager (e.g., UI manager 104 of FIG. 1 or 2) determining actions associated with a GUI element. The example implementations 500-1 through 500-4 each illustrate a computing device 502 having a display 504, a GUI element 506 (touch target 506), and additional GUI element 508 (intent bubble 508) and GUI element 512 (voice hints 512). Although not shown, the computing device 502 may also include one or more processors, CRM, a speaker, one or more microphones, additional sensors, and so forth, as described with respect to FIG. 2. The one or more processors may execute computer-readable instructions that are stored on the CRM to provide a UI manager that enables some or all of the functionalities described herein.

Illustrated at 500-1 are the computing device 502, the display 504, the touch target 506, the intent bubble 508, and a first user input 510 (touch input 510). In this example, the touch target 506 may be a messaging application, a message within the messaging application, a notification of the message from the messaging app, an email application, an email within the email application, a notification of the messaging app, and so forth. Generally, the touch target 506 illustrated at 500-1 can be any communication-related touch target. Also illustrated at 500-1 are the voice hints 512. The voice hints 512 may present a user with key words or phrases that the user may speak to invoke an action by the UI manager. As illustrated, the voice hints 512 that are associated with a communication-related touch target include key words such as archive, delete, forward, react (e.g., like, dislike, laugh), and reply. The voice hints 512 are all actions that a communication-related touch target (e.g., application, notification) can perform.

In aspects, the UI manager may determine the voice hints 512 using a predetermined list of actions. For example, a developer of a communication-related application can generate the list of actions and include them as part of the application as a list, a lookup table, or any other suitable form of digital data that can be stored on the CRM of the computing device 502. The UI manager may reference this list and direct the display 504 to output the voice hints 512. As another example, a developer may provide rules in computer code that defines the touch target 506 from which the voice hints 512 may be synthesized by the UI manager. The provided rules may include patterns (e.g., of spoken text) with placeholders that can be replaced by spoken text from a user. The provided rules may be run in reverse so that rather than matching spoken words to an action (e.g., an intent), the UI manager can synthesize an intent from the provided rules. As an example, assuming the touch target 506 is a messaging application, then the developer-provided rules may include that the messaging application can send a text message, send a picture message, send a video message, and so forth. By running the rules in reverse, the UI manager may determine the voice hints 512 by synthesizing intents from the rules. Thus, the voice hints 512 may include phrases such as “send a text message,” “send a picture message,” “send a video message,” and so forth. Additionally, because a message is sent to a recipient, the voice hints 512 may further include, at the end of the phrases, the word “to” followed by a recipient name, phone number, email address, and the like.

In other aspects, the UI manager may determine the voice hints 512 using a large language model (LLM) or another appropriate machine-learned (ML) model configured to interpret traits (e.g., actions, tasks) that are associated with and imply functionalities of the touch target 506. The LLM or appropriate ML model can be trained to receive input data of one or more types and, in response, provide output data of one or more types. For example, an LLM can be trained on various coding language (e.g., Java, C++, Python) databases (e.g., GitHub) as input data and provide natural language (e.g., American English, Spanish) as output data, which can be used as the voice hints 512. Once trained, the LLM may be stored as part of the UI manager as computer-readable instructions on the CRM of the computing device 502. By so doing, the UI manager may provide computer code of a touch target (e.g., an application, a notification, an image, a video, text) as input data to the LLM, which may analyze the computer code to generate the voice hints 512. At 500-2, FIG. 5 illustrates that the voice hints 512 may cycle in a rotating fashion, indicating that multiple key words or phrases are usable with the touch target 506. The UI manager may cycle through the voice hints 512 until the user speaks a key word or phrase.

FIG. 5 illustrates at 500-3 that the touch target 506 may be a graphical element, including an image, a video, a graphics interchange format (GIF), and the like. The UI manager may provide the voice hints 512 responsive to the user providing the touch input 510 (e.g., long-press touch input). The voice hints 512 may be determined by the UI manager based on a predetermined list provided by a developer and/or generated using an LLM. The UI manager may additionally or alternatively reference traits associated with the graphical element touch target 506. For example, images, videos, and GIFs can be shared, copied, edited, deleted, and so forth. Based on these traits, the UI manager can provide the voice hints 512 accordingly. In this example, the voice hints 512 that are associated with the graphical element touch target 506 include key words edit, move (e.g., to a different directory or folder), delete (e.g., from the computing device 502, from a directory or folder), add to (e.g., a directory or folder), and share.

At 500-4, FIG. 5 illustrates that the touch target 506 can be an application icon. The UI manager may reference a predetermined list of actions associated with an application, use an LLM to interpret application code, or reference application traits to generate the voice hints 512. In this example, the UI manager references traits associated with an application to generate the voice hints 512, which include key words such as delete (e.g., the application from the computing device 502, the application from a home screen or folder), share, and pause (e.g., prohibit the application from using resources of the computing device 502).

### Example Use Cases

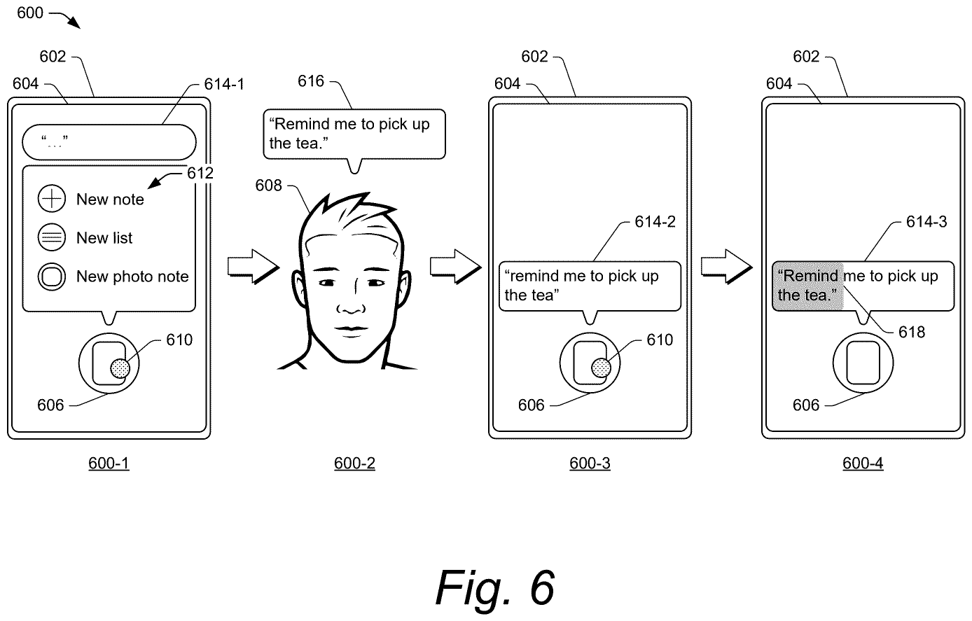

FIG. 6 illustrates an example implementation 600 of utilizing a UI manager (e.g., UI manager 104 of FIG. 1 or 2) to interact with a notetaking application. FIG. 6 illustrates a computing device 602, a display 604, a touch target 606 (e.g., a GUI element), and a user 608. The UI manager, the computing device 602, and the display 604 are similar to the UI manager 104, the computing device 102, and the display 108 illustrated in FIG. 2 and described above, except as detailed below.

In this example, the touch target 606 is a notetaking application (notetaking application 606). The display 604 outputs a GUI including a plurality of GUI elements with which the user 608 may interact. Illustrated at 600-1, the user 608 provides a touch input 610 that is associated with the notetaking application 606. In this example, the touch input 610 is a press-and-hold touch input. Responsive to the touch input 610, the UI manager determines a list of actions that are associated with the notetaking application 606 and presents them as additional GUI elements 612 (voice hints 612). The voice hints 612 may include key phrases such as new note, new list, and new photo note. The voice hints 612 indicate to the user 608 some of the actions that are possible by the notetaking application 606. Other actions not shown may include reminders, checklists, audio notes, drawn notes, and so forth. The UI manager also presents an intent bubble 614-1 that includes a voice cursor (e.g., an ellipsis) that indicates to the user 608 where spoken text will be inserted.

At 600-2, FIG. 6 illustrates the user 608 providing a voice input 616. The user 608 may provide the voice input 616 while maintaining the press-and-hold touch input 610. In this way, the user 608 interacts with the notetaking application 606 via the UI manager in a similar fashion to a walkie talkie. Said differently, the GUI element that is associated with the notetaking application 606 behaves as a push-to-talk button, where the UI manager may receive the voice input 616 only while the press-and-hold touch input 610 is maintained on the GUI element. The voice input 616, in this example, requests that the notetaking application 606 create a reminder to pick up tea.

At 600-3, FIG. 6 illustrates the computing device 602, the display 604, and the press-and-hold touch input 610 associated with the notetaking application 606 that is maintained by the user 608. FIG. 6, at 600-3, also illustrates that the UI manager no longer presents the voice hints 612 because the user 608 has provided the voice input 616. Further, the intent bubble 614-1 has transitioned to an intent bubble 614-2, where the voice cursor has been replaced by the spoken text of the voice input 616.

FIG. 6 illustrates, at 600-4, the computing device 602, the display 604, and the notetaking application 606. FIG. 6, at 600-4, further illustrates that the user 608 is no longer providing the press-and-hold touch input 610. Responsive to the user 608 no longer providing the touch input 610, the UI manager presents, in an intent bubble 614-3, an interpretation of the spoken text as indicated by a proper sentence having correct capitalization and punctuation. The UI manager also presents a countdown 618 within the intent bubble 614-3 to the user 608. The countdown 618 within the intent bubble 614-3 may allow time for the user 608 to notice potential errors in the interpretation of the voice input 616. As illustrated, the UI manager did not make an error interpreting the voice input 616 from the user 608. The user 608 may allow the countdown 618 to complete, at which point the notetaking application 606 can create the reminder to pick up the tea.

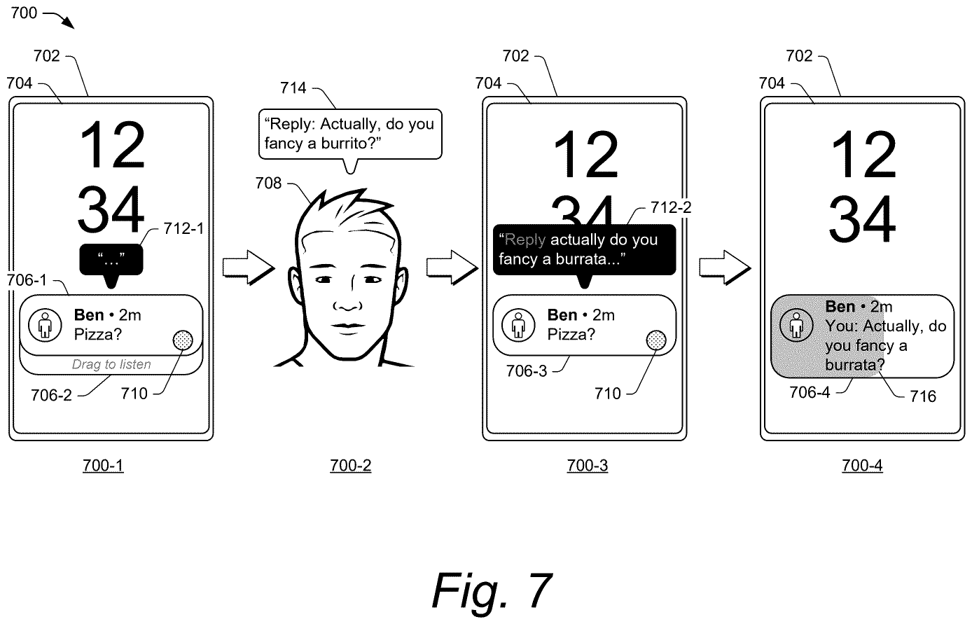

FIG. 7 illustrates an example implementation 700 of utilizing a UI manager to interact with a notification 706-1. The notification 706-1 is a GUI element of a GUI output by a display 704 of a computing device 702. The UI manager, the computing device 702, and the display 704 are similar to the UI manager 104, the computing device 102, and the display 108 illustrated in FIG. 2 and described above, except as detailed below. In this example, the notification 706-1 is associated with a messaging application of the computing device 702. As illustrated, the notification 706-1 includes a message from a friend of a user 708 asking the user 708 if he wants pizza.

At 700-1, the user 708 provides a press-and-hold touch input 710 at a location of the GUI output by the display 704 associated with the notification 706-1. Responsive to the touch input 710, the UI manager presents additional GUI elements, including an intent bubble 712-1 and a modification 706-2 to the notification 706-1. The intent bubble 712-1 includes a voice cursor to indicate to the user 708 where spoken text will be inserted. The modification 706-2 to the notification 706-1 indicates to the user 708 that he can drag the touch input 710 in a downward direction to listen to the message from his friend.

At 700-2, FIG. 7 illustrates the user 708 providing a voice input 714 to the UI manager. The user 708 provides the voice input 714 while maintaining the press-and-hold touch input 710. The voice input 714 includes the user 708 selecting a reply option to ask his friend if he would rather have a burrito. Additionally or alternatively, as described with reference to method 300 of FIG. 3, replying to the message contained in the notification 706-1 may be a default action. Accordingly, the user 708 may speak the phrase “Actually, do you fancy a burrito?” without the key word “Reply.” In this example, the UI manager may select the “reply” option automatically and use the phrase from the user 708 as contents of the message.

At 700-3, FIG. 7 illustrates changes to various GUI elements, including the notification 706-1, the notification modification 706-2, and the intent bubble 712-1 from 700-1. As illustrated, a notification 706-3 does not include the notification modification 706-2 because the user 708 provided the voice input 714 to the UI manager. Also illustrated are the touch input 710 and an intent bubble 712-2, in which the voice cursor is replaced by spoken text of the voice input 714. In this example, the UI manager misunderstood the word “burrito” as the word “burrata.”

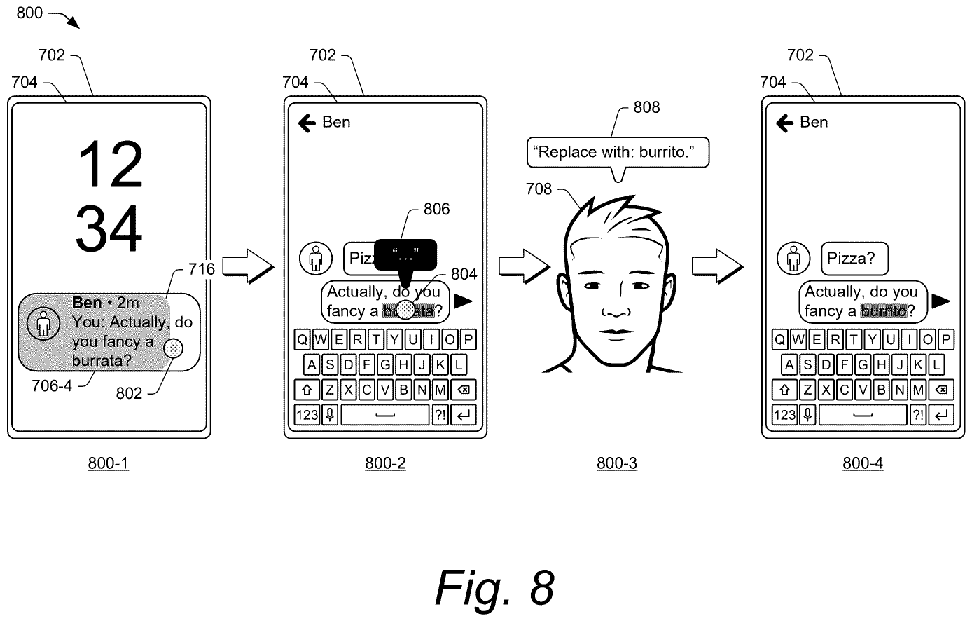

At 700-4, FIG. 7 illustrates a change to the notification 706-3 from 700-3 to a notification 706-4, which includes the spoken text from the voice input 714 of the user 708. As illustrated, the notification 706-4 includes the incorrect spelling of the word “burrito,” the intent bubble 712-2 is no longer displayed, and a countdown 716 is displayed. The UI manager begins the countdown 716 responsive to the user 708 releasing the touch input 710. The countdown 716 indicates to the user 708 that the computing device 702 will send the message with the incorrect spelling of the word “burrito” via the messaging application associated with the notification 706-4. The countdown 716 allows the user 708 to interrupt the sending of the message, which is described with reference to FIG. 8.

FIG. 8 illustrates an example implementation 800 of utilizing a UI manager to edit text. Included in FIG. 8 are the computing device 702, the display 704, the notification 706-4, the user 708, and the countdown 716 from FIG. 7. As illustrated at 800-1, the countdown 716 has progressed but has not completed, and the spoken text includes the incorrect spelling of “burrito.” The user 708 may provide a touch input 802 (e.g., a tap touch input) to open the messaging application associated with the notification 706-4.

At 800-2, FIG. 8 illustrates the messaging application associated with the notification 706-4. Further at 800-2, the user 708 provides a second touch input 804 (e.g., a press-and-hold touch input) and the UI manager, responsive to the second touch input 804, outputs (e.g., by the display 704) an intent bubble 806 including a voice cursor. In some implementations, a press-and-hold touch input can be a recognized user input to an OS of the computing device (e.g., contextual menus, copy-and-paste menus). In such implementations, the user 708 may provide a longer duration press-and-hold touch input to bypass OS functionality and invoke the UI manager to output the intent bubble 806. Further, the UI manager may provide a contextual clue (e.g., a visual cue, an audio cue, a haptic cue) to the user 708 that indicates that the longer duration has been achieved. The voice cursor (e.g., an ellipsis) indicates to the user 708 where spoken text will be inserted. The second touch input 804, as illustrated, selects and highlights the incorrect spelling of “burrito.” The UI manager, although not shown, may determine one or more actions associated with the selected word. The one or more actions may be determined based on a predetermined list of actions or rules run in reverse (e.g., provided by a developer), an LLM, or another appropriate ML model. For example, an LLM may interpret traits associated with text that can include an ability to modify, copy, or cut the text.

At 800-3, FIG. 8 illustrates the user 708 providing a voice input 808. In this example, the voice input 808 includes instructions for the UI manager to replace the incorrect spelling of “burrata” with the correct spelling of “burrito.” As described with reference to FIGS. 3 and 7, an action of the one or more actions may be a default action associated with a selected UI element. In the present example, the default action for the text selected by the second touch input 804 may be to replace the selected text. Accordingly, the user 708 may speak only the word “burrito” and the UI manager may select the “replace” action by default. Other possible actions include, for example, making the text bold or italic, cutting the text, copying the text, or deleting the text.

At 800-4, FIG. 8 illustrates that the user 708 releases the touch input 804. Responsive to the user 708 releasing the touch input 804 and based on the voice input 808, the UI manager replaces “burrata” with “burrito,” as illustrated. The user 708 can, for example, tap a send button to the right of the message to continue his conversation with his friend.

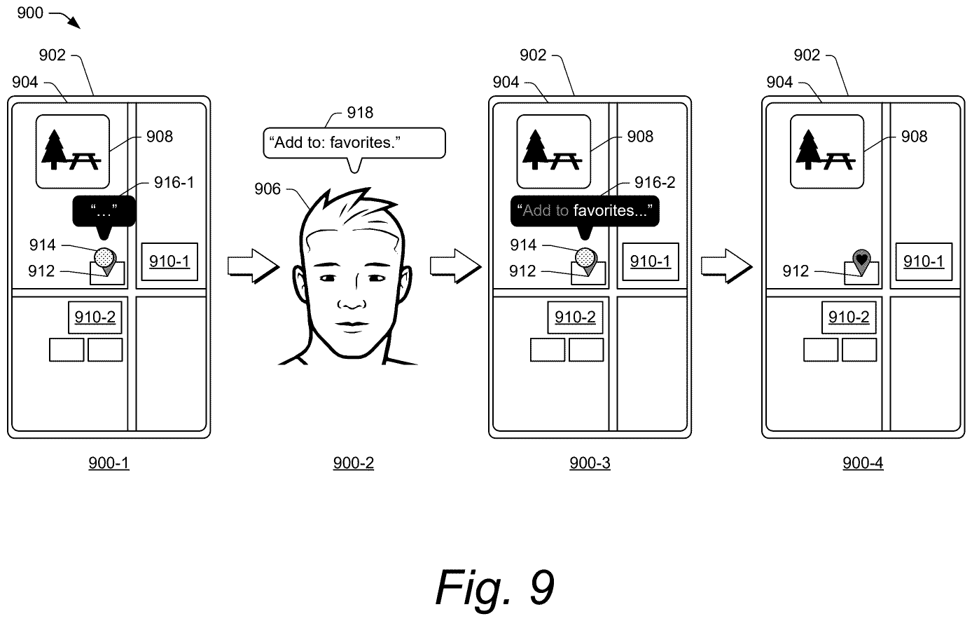

FIG. 9 illustrates an example implementation 900 of utilizing a UI manager to interact with a mapping application. FIG. 9 illustrates a computing device 902 having a display 904 and a user 906. The UI manager, the computing device 902, and the display 904 are similar to the UI manager 104, the computing device 102, and the display 108 illustrated in FIG. 2 and described above, except as detailed below.

Illustrated at 900-1, the display 904 includes the mapping application having various GUI elements, including a park 908, various buildings 910-1 and 910-2 (e.g., houses, businesses, event centers), and a touch target 912. In this example, the touch target 912 is a location of interest (e.g., a business) to the user 906. Also illustrated is a press-and-hold touch input 914 provided by the user 906. The touch input 914 is associated with the touch target 912 of interest to the user 906, and the UI manager, responsive to the touch input 914, outputs an intent bubble 916-1. The intent bubble 916-1 includes an ellipsis as a voice cursor that indicates to the user 906 where spoken text will be inserted.

Not illustrated in FIG. 9 are one or more actions (e.g., voice hints 612) that may be associated with the touch target 912. As examples, actions may include sharing the location of interest with a friend or colleague, acquiring directions to the location of interest, marking the location of interest as a favorite, or visiting a website associated with the location of interest (e.g., a business home page). Although not illustrated, the UI manager may present the one or more actions as voice hints, such as the voice hints 612 described with reference to FIG. 6.

At 900-2, FIG. 9 illustrates the user 906 providing a voice input 918. In this example, the voice input 918 includes instructions from the user 906 to add the location of interest (e.g., touch target 812) to a favorites list. The user 906 provides the voice input 918 while maintaining the press-and-hold touch input 914 (now shown).

At 900-3, FIG. 9 illustrates that the intent bubble 916-1 has been modified to an intent bubble 916-2 that includes spoken text of the voice input 918 in place of the voice cursor. By so doing, the UI manager indicates to the user 906 via the intent bubble 916-2 that the voice input 918 was received and understood. Also illustrated is the touch input 914 being maintained by the user 906. From 900-3 to 900-4, the user 906 releases the touch input 914.

Responsive to and based on the release of the touch input 914 and the voice input 918, the UI manager adds the location of interest to the favorites list. FIG. 9 illustrates this at 900-4, where the touch input 914 is not present and the touch target 912 now includes a heart to indicate that the location of interest was added to the favorites list. Although not shown, a countdown, like those described with reference to FIGS. 6 through 8, may be used to delay adding the location of interest to the favorites list so the user 906 has a period of time (e.g., 1 s, 2 s) to check that the voice input 918 was interpreted correctly.

### Additional Examples

In the following section, additional examples are provided.

Example 1: A method comprising: outputting, by a computing device, a user interface (UI) comprising a plurality of UI elements; receiving, by the computing device, a user input that selects a UI element of the plurality of UI elements; determining, by the computing device and responsive to the selection of the UI element, one or more actions that are associated with the selected UI element; outputting, by the computing device, one or more additional UI elements that are associated with the one or more actions; receiving, by the computing device, a voice input that selects an additional UI element of the one or more additional UI elements, the selected additional UI element associated with an action of the one or more actions; and performing, by the computing device and responsive to the voice input, the action associated with the selected additional UI element.

Example 2: The method of example 1, wherein: the one or more additional UI elements include at least a first additional UI element and a second additional UI element; and outputting the one or more additional UI elements include outputting the first additional UI element for a duration of time before outputting the second additional UI element for the duration of time.

Example 3: The method of example 1 or 2, wherein: the user input is a maintained press and hold touch input; the determination of the one or more actions that are associated with the selected UI element is responsive to the maintenance of the press and hold touch input; the voice input includes receiving an indication of a termination of the voice input; and the indication of the termination of the voice input is a termination of maintenance of the press and hold touch input.

Example 4: The method of example 1 or 2, wherein: the user input is a long press touch input; the determination of the one or more actions that are associated with the selected UI element is responsive to a termination of the long press touch input; the voice input includes receiving an indication of a termination of the voice input; and the indication of the termination of the voice input is a termination of the voice input.

Example 5: The method of example 4, wherein the termination of the voice input includes a delay.

Example 6: The method of example 1 or 2, wherein: the user input is a first voice input and the voice input is a second voice input; the determination of the one or more actions that are associated with the selected UI element is responsive to a termination of the first voice input; the second voice input includes receiving an indication of a termination of the second voice input; and the indication of the termination of the second voice input is a termination of the second voice input.

Example 7: The method of example 6, wherein the termination of the second voice input includes a delay.

Example 8: The method of any one of the preceding examples, further comprising: receiving, by the computing device and prior to the performing of the action, a user input.

Example 9: The method of example 8, wherein the user input is at least one of: a touch input; or an audio input.

Example 10: The method of any one of the preceding examples, wherein determining the one or more actions uses: a machine learned (ML) model; a predetermined list of actions; or a predetermined set of rules.

Example 11: The method of example 10, wherein determining the one or more actions uses the ML model and where the ML model is a large language model (LLM).

Example 12: The method of example 11, further comprising: providing computer code of the selected UI element as input data to the LLM; and determining the one or more actions that are associated with the selected UI element by analyzing the computer code using the LLM.

Example 13: The method of example 10, wherein determining the one or more actions uses the plurality of UI elements and the plurality of UI elements include: the predetermined set of rules are run in reverse; and determining the one or more actions includes synthesizing the one or more actions from running the predetermined set of rules in reverse.

Example 14: A computing device comprising: at least one display; at least one touchscreen; at least one microphone; at least one speaker; at least one processor; and computer readable media storing instructions that, when executed by the at least one processor, cause the at least one processor to implement a UI manager utilizing the at least one display, the at least one touchscreen, the at least one microphone, the at least one speaker, and the at least one processor by performing the method of any one of examples 1-13.

Example 15: Computer readable media comprising instructions that, when executed by at least one processor, cause the at least one processor to perform the method of any one of examples 1-13.

### Conclusion

Throughout this discussion, examples are described where a UI manager of a computing device (e.g., a smartphone) analyzes information (e.g., location data, contact data) associated with a user. Further to the description above, a user may be provided with controls allowing the user to make an election as to both if and when systems, programs, and/or features described herein may enable collection of information (e.g., location data). The UI manager may be configured to only use the information after receiving explicit permission from the user of the computing device to use the data. For example, in situations where the UI manager may analyze image data for location features to direct the user, individual users may be provided with an opportunity to provide input to control whether programs or features of the computing device can collect and make use of the data. Further, individual users may have constant control over what programs can or cannot do with the information. In addition, information collected may be pre-treated in one or more ways before it is transferred, stored, or otherwise used so that personally identifiable information is removed. Thus, the user may have control over whether information is collected about the user and the computing device of the user and how such information, if collected, may be used by the UI manager, the computing device, and/or a remote computing system.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations of systems and techniques of, and apparatuses enabling, UI managers have been described in language specific to certain features and/or methods, the subject of the appended Claims is not necessarily limited to the specific features or methods described. Rather, the specific features and methods are disclosed as example implementations of UI managers.

1. A method comprising:
outputting, by a computing device, a user interface (UI) comprising a plurality of UI elements;
receiving, by the computing device, a touch input that selects a UI element of the plurality of UI elements;
determining, by the computing device and responsive to the selection of the UI element, one or more actions applicable to an application associated with the UI element;
outputting, by the computing device, one or more additional UI elements that are associated with the one or more actions;
receiving, by the computing device, a voice input that selects an additional UI element of the one or more additional UI elements, the additional UI element associated with an action of the one or more actions; and
performing, by the computing device and responsive to the voice input, the action associated with the additional UI element.

2. The method of claim 1, wherein:
the one or more additional UI elements include at least a first additional UI element and a second additional UI element; and
outputting the one or more additional UI elements include outputting the first additional UI element for a duration of time before outputting the second additional UI element for the duration of time.

3. The method of claim 1, wherein:
the touch input is a press-and-hold touch input on the UI element;
determining the one or more actions that are associated with the UI element is performed while the press-and-hold touch input is maintained;
receiving the voice input includes receiving the voice input while the press-and-hold touch input is maintained and receiving an indication of a termination of the voice input; and
the indication of the termination of the voice input is a release of the press-and-hold touch input.

4. The method of claim 1, wherein:
the touch input is a long-press touch input;
determining the one or more actions that are associated with the UI element is responsive to a termination of the long-press touch input;
receiving the voice input includes receiving an indication of a termination of the voice input; and
the indication of the termination of the voice input is a termination of the voice input.

5. The method of claim 4, wherein the termination of the voice input includes a delay.

6-9. (canceled)

10. The method of claim 1 claims, wherein determining the one or more actions uses:
a machine-learned (ML) model;
a predetermined list of actions; or
a predetermined set of rules.

11. The method of claim 10, wherein determining the one or more actions uses the ML model and wherein the ML model is a large language model (LLM).

12. The method of claim 11, further comprising:
providing computer code of the UI element as input data to the LLM,
wherein determining the one or more actions that are associated with the UI element includes analyzing the computer code using the LLM.

13. The method of claim 10, wherein determining the one or more actions uses the plurality of UI elements, wherein:

3. the predetermined set of rules are run in reverse; and
determining the one or more actions includes synthesizing the one or more actions from running the predetermined set of rules in reverse.

14. A computing device comprising:
at least one display;
at least one touchscreen;
at least one microphone;
at least one speaker;
at least one processor; and
computer-readable media storing instructions that, when executed by the at least one processor, cause the at least one processor to implement a user interface (UD) manager utilizing the at least one display, the at least one touchscreen, the at least one microphone, the at least one speaker, and the at least one processor to:
output, via the at least one display, a UI comprising a plurality of UI elements;
receive, via the at least one touchscreen, a touch input that selects a UI element of the plurality of UI elements;
determine, responsive to the touch input that selects the UI element, one or more actions applicable to an application associated with the UI element;
output, via the UI, one or more additional UI elements that are associated with the one or more actions;
receive, via the microphone, a voice input that selects an additional UI element of the one or more additional UI elements, the additional UI element associated with an action of the one or more actions; and
perform, responsive to the voice input, the action associated with the additional UI element.

15. (canceled)

16. The computing device of claim 14, wherein:
the UI element is an application icon for the application; and
the one or more actions include at least one of pausing the application, clearing a cache memory associated with the application, sharing the application, or moving the application on a home screen.

17. The computing device of claim 14, wherein:
the touch input is a press-and-hold touch input on the UI element;
the one or more actions that are associated with the UI element are determined while the press-and-hold touch input is maintained;
the voice input is received while the press-and-hold touch input is maintained and the voice input includes an indication of a termination of the voice input; and
the indication of the termination of the voice input is a release of the press-and-hold touch input.

18. The computing device of claim 14, wherein:
the touch input is a long-press touch input;
the one or more actions that are associated with the UI element are determined responsive to a termination of the long-press touch input;
the voice input includes an indication of a termination of the voice input;
the indication of the termination of the voice input is a termination of the voice input; and
the termination of the voice input includes a delay.

19. The computing device of claim 14, wherein the one or more actions are determined using a machine-learned (ML) model, and wherein the ML model is a large language model (LLM).

20. The computing device of claim 14, wherein:
each UI element of the plurality of UI elements includes a predetermined set of rules in computer code that define the UI element; and
the one or more actions are determined by running the rules in reverse and synthesizing an intent from the rules.

21. Computer-readable media comprising instructions that, when executed by at least one processor of a computing device, cause the at least one processor to perform operations including:
outputting, by the computing device, a user interface (UI) comprising a plurality of UI elements;
receiving, by the computing device, a touch input that selects a UI element of the plurality of UI elements;
determining, by the computing device and responsive to the selection of the UI element, one or more actions applicable to an application associated with the UI element;
outputting, by the computing device, one or more additional UI elements that are associated with the one or more actions;
receiving, by the computing device, a voice input that selects an additional UI element of the one or more additional UI elements, the additional UI element being associated with an action of the one or more actions; and
performing, by the computing device and responsive to the voice input, the action associated with the additional UI element.

22. The computer-readable media of claim 21, wherein:
the touch input is a press-and-hold touch input on the UI element;
the one or more actions are determined while the press-and-hold touch input is maintained on the UI element;
the voice input is received while the press-and-hold touch input is maintained on the UI element;
the voice input includes an indication of a termination of the voice input; and
the indication of the termination of the voice input is a release of the press-and-hold touch input.

23. The computer-readable media of claim 21, wherein the operations include:
providing computer code of the UI element as input data to a large language model (LLM); and
analyzing the computer code using the LLM to determine the one or more actions.

24. The computer-readable media of claim 21, wherein:
each UI element of the plurality of UI elements includes a predetermined set of rules in computer code that define the UI element; and
the one or more actions are determined by running the rules in reverse and synthesizing an intent from the rules.

25. The computer-readable media of claim 21, wherein:
the touch input is a long-press touch input;
the one or more actions that are associated with the UI element are determined responsive to a termination of the long-press touch input;
the voice input includes an indication of a termination of the voice input;
the indication of the termination of the voice input is a termination of the voice input; and
the termination of the voice input includes a delay.
